(19) United States
(12) Patent Application Publication
(10) Pub. No.: US 2014/0197782 A1
(43) Pub. Date: Jul. 17, 2014

(54) WIRELESS CHARGER WITH COMBINED ELECTRIC RADIATION SHIELDING AND CAPACITIVE SENSING FUNCTIONS

(71) Applicant: LITE-ON IT CORPORATION, Taipei (TW)

(72) Inventors: Stefan GRAF, Wetzlar (DE); Andre WALDSCHMIDT, Wetzlar (DE); Karsten ROTH, Wetzlar (DE); Lars LINDENSTRUTH, Wetzlar (DE)

(73) Assignee: LITE-ON IT CORPORATION, Taipei (TW)

(21) Appl. No.: 13/742,159

(22) Filed: Jan. 15, 2013

(51) Int. Cl. H02J 7/00

(52) U.S. Cl. CPC H02J 7/007
USPC 320/108; 320/137

(57) ABSTRACT

A wireless charger with combined electric radiation shielding and capacitive sensing functions is provided. The wireless charger comprises a charging module, a capacitive sensor, and a control unit. The charging module comprises a first coil, a placing area, and a comb-shaped shielding located between the placing area and the first coil. The capacitive sensor is connected to the comb-shaped shielding to detect the capacitance varient between the comb-shaped shielding and the environment. When the wireless charger is in a standby mode, the comb-shaped shielding is for sensing capacitance. When the capacitance varient exceeds a predefined threshold and an electronic device for wireless charging is placed on the placing area, the control unit switches the wireless charger to a charging mode and the comb-shaped shielding is for electric radiation shielding.

### BACKGROUND OF THE INVENTION

1. Technical Field

The present invention relates to a wireless charger. More particularly, the present invention relates to a wireless charger with combined electric radition shielding and capacitive sensing functions.

2. Description of Related Art

Nowadays, complex electronic circuitry is found in all sorts of devices used in the home or other places. Such devices are usually charged by a wired method or contain a battery to provide necessary electricity. However the length of the wires could limit the usage range of the devices and the wires easily get entangled with other wire, causing inconvenience. Therefore, inductive charging (also known as wireless charging) of electronic devices is increasingly popular. The inductive charging is fulfilled by electromagnetic induction. A major problem of the wireless charging is electromagnetic interference (EMI). EMI is a common problem which occurs with electronic devices when the performance of a device is disturbed or interrupted by electromagnetic radiation or electromagnetic conduction. The wireless transmission of electric radiation of the inductive charging device (wireless charger) might influence other electronic equipments. Generally, to recognize that there is a chargeable device on the charging pad of the wireless charger, standard wireless charger is pinging all the time which leads to additional EMS (electromagnetic susceptibility) issues. Therefore, there still remains a solution to solve the above mentioned issues.

### SUMMARY OF THE INVENTION

One aspect of the present invention is to provide a wireless charger for charging an electronic device with a second coil, comprising a charging module, which comprises a first coil electromagnetically coupled to the second coil, a placing area for the electronic device to be placed, and a comb-shaped shielding located between the placing area and the first coil; a capacitive sensor, which is connected to the comb-shaped shielding to detect the capacitance varient between the comb-shaped shielding and the environment; a control unit, which is connected to the comb-shaped shielding and the capacitive sensor and records the capacitance varient, wherein when the capacitance varient exceeds a predefined threshold, the control unit sends a ping signal to the electronic device, and if the electronic device responds, the control unit switches the charging module from a standby mode to a charging mode to wireless chage the electronic device and switches the comb-shaped shielding to be connected to the ground.

Another aspect of the present invention is to provide a method for combining electric radiation shielding and capacitive sensing functions to a wireless charger, comprising: (a) detecting a capacitance varient between a comb-shaped shielding of the wireless charger and the environment via a capacitive sensor connected to the comb-shaped shielding in a standby mode; (b) transmitting a ping signal to confirm an electronic device is to be charged when the capacitance varient exceeds a predefined threshold by a controller; (c) switching the comb-shaped shielding to be connected a ground and powering on the wireless charger to perform wireless charging when a response to the ping signal is received in a charging mode; and (d) switching the wireless charger back to the standby mode when the capacitance varient is under the predefined threshold.

### BRIEF DESCRIPTION OF THE DRAWINGS

The accompanying drawings, together with the specificaion, illustrate exemplary embodiments of the present invention, and, together with the description, serve to explain the principles of the present invention.

FIG. 1 is a schematic diagram showing an embodiment of the wireless charger of the invention.

FIG. 2 shows a pictorial drawing of the wireless charger of the invention with a portable electronic device.

FIG. 3 shows a flow chart illustrating an operation of the embodiment of FIG. 1.

FIG. 4 shows a chart of the electric radiation emitted from a wireless charger in a charging mode without the comb-shaped shielding.

FIG. 5 shows a chart of the electric radiation emitted from a wireless charger in a charging mode with the comb-shaped shielding of the present invention.

### DETAILED DESCRIPTION OF THE INVENTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

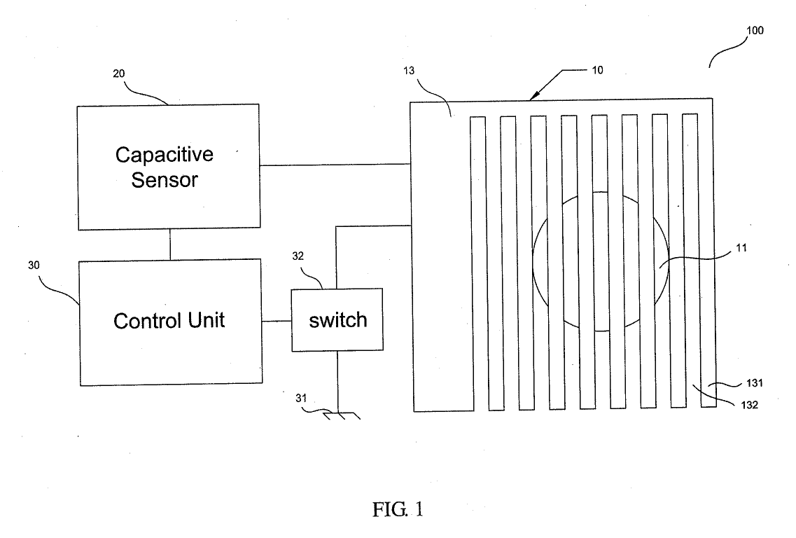

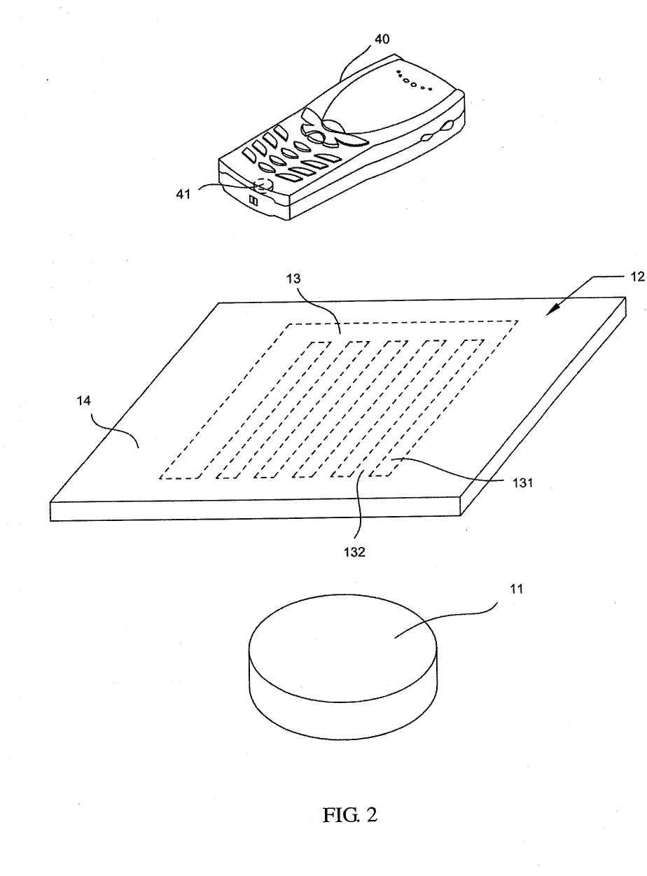

FIG. 1 is a schematic diagram showing an embodiment of the wireless charger 100 of the invention. FIG. 2 shows a pictorial drawing of the wireless charger of the invention with a portable electronic device. The wireless charger 100 is for charging an electronic device 40 wirelessly. In general, the electronic device 40 has a second coil 41 in it so as to take power from the electromagnetic field generated by the wireless charger 100 and convert it into electrical current to charge the battery in the electronic device 40. As shown in FIG. 1, the wireless charger 100 comprises a charging module 10, a capacitive sensor 20, and a control unit 30. The charging module 10 comprises at least one first coil 11, a placing area 12, and a comb-shaped sheilding 13. The first coil 11 is electromagnetically coupled to the second coil 41 embedded in the electronic device 40, and may be connected to a power supply. The placing area 12 is for the electronic device 40 to be placed on opposite to the first coil 11 to perform wireless charging, and the comb-shaped shielding 13 is located between the placing area 12 and the first coil 11.

In an exemplary of the present invention, the wireless charger 100 has two modes, namely, a standby mode and a charging mode. In the standby mode, the comb-shaped shielding 13 is for sensing capacitance; whereas in the charging mode, the comb-shaped shielding 13 is for electric radiation shielding. Thus, a combined electric radiation shielding and capacitive sensing functions to a wireless charger 100 is provided. The conversion of the two modes will discuss below.

The capacitive sensor 20 is connected to the comb-shaped shielding 13 to detect the capacitance varient between the comb-shaped shielding 13 and the environment. In general, the capacitive sensor 20 can directly sense electrical fields. Capacitive sensor 20 may be composed of conductive sensing electrodes, a dielectric, and detection circuits that detect changes in capacitance. The capacitive sensor 20 may be designed as a capacitive sensor integrated circuit (IC). As the comb-shaped shielding 13 is connected to the capacitive sensor 20, it acts as a capacitive sensor electrode in the standby mode. If an object (electronic device 40) approaches the comb-shaped shielding 13, the capacitance between the comb-shaped shielding 13 and the environment changes, and the capacitance varient is detected by the detection circuit of the capacitive sensor 20.

The control unit 30 is also connected to the comb-shaped shielding 13 and the capatitive sensor 20 to record/store the capacitance varient. When the capacitance varient exceeds a predefined threshold, the control unit 30 sends a ping signal to the electronic device 40. In this way, the ping operation is started only if the electronic device 40 is approaching. If the electronic device 40 responds, the control unit 30 switches the charging module 100 from a standby mode to a charging mode to wireless charge the electronic device 40 and switches the comb-shaped shielding 13 to be connected to the ground 31.

The term “ping signal” is any type of wireless signal transmitted from a first interactive wireless device (in the present invention, the first interactive wireless device is the control unit 30) in order to obtain information from a second interactive wireless device (in the present invention, the second interactive wireless device is the electronic device 40 which is to be charged) within a particular range of the first interactive wireless device. The ping signal is typically a short range signal for communicating with the second interactive wireless devices in a closer region, and may be transmitted from the control unit 30 to the electronic device 40 via the first coil 11. The second interactive wireless device within range receives the ping signal, and, in response, sends response through a wireless transmission. The response may also include additional information, such as information concerning its remaining power or capabilities, etc. The first interactive wireless device may adjust the wireless charging time according to the remaining power and capability in the battery of the second interactive wireless device.

The term “wireless charging,” also called “inductive charging,” refers to use an electromagnetic field to transfer energy between two objects (one is the wireless charger 100 and the other is the electronic device 40). Energy is sent through inductive coupling to the electronic device 40, which then can use that energy to charge a battery in the electronic device 40 or run the electronic device 40. Typically, the wireless charger 100 uses the first coil 11 as an induction coil to connect to an alternating current (AC) power supply and to create an alternating electromagnetic field within a charging case station, and the second coil 41 in the electronic device 40 takes power from the electromagnetic field and converts it into electrical current to charge the battery. The two induction coils 11, 41 in proximity combine to form an electrical transformer.

While performing the wireless charging (in charging mode), the H-fields (magnetic fields) charge the electronic device 40, but the wireless charger 100 also generate E-fields. The E-fields radiate and disturb other devices nearby the wireless charger 100. The comb-shaped shielding 13 is used as a filter to shield the electric radiation from E-fields and also enables an inductive magnetic (H-fields) coupling to the electronic device 40. In addition, the shielding ability of the comb-shaped shielding 13 is improved because the control unit 30 switches the comb-shaped shielding 13 to be connected to the ground 31, thus, the radiated emission is reduced. If the object approaching the wireless charger 100 is not detected as a receiver, such as it does not respond to the ping signal, the control unit 30 keeps the wireless charger 100 in the standby mode. The control unit 30 may further comprise a switch 32, which is electrically connected between the ground 31 and the comb-shaped shielding 13. In a preferable embodiment, the switch 32 is a transistor.

The comb-shaped shielding 13, also called as Farady shield, can be a metal sheet or foils or other materials that are suitable for shielding, which comprises a plurality of parallel segments 131, and spaces 132 are arranged between each adjacent segments 131. As a preferable embodiment, the comb-shaped shielding 13 can be printed on a PCB board 14, to strengthen the stucture or to reduce the use of the metal materials. The comb-shaped shielding 13 can cover the spacings of the first coil 11, and the combination of two or more comb-shaped shielding 13 with different directions (in relation to the first coil 11 and against each other) and located in different layers are also included in the present invention.

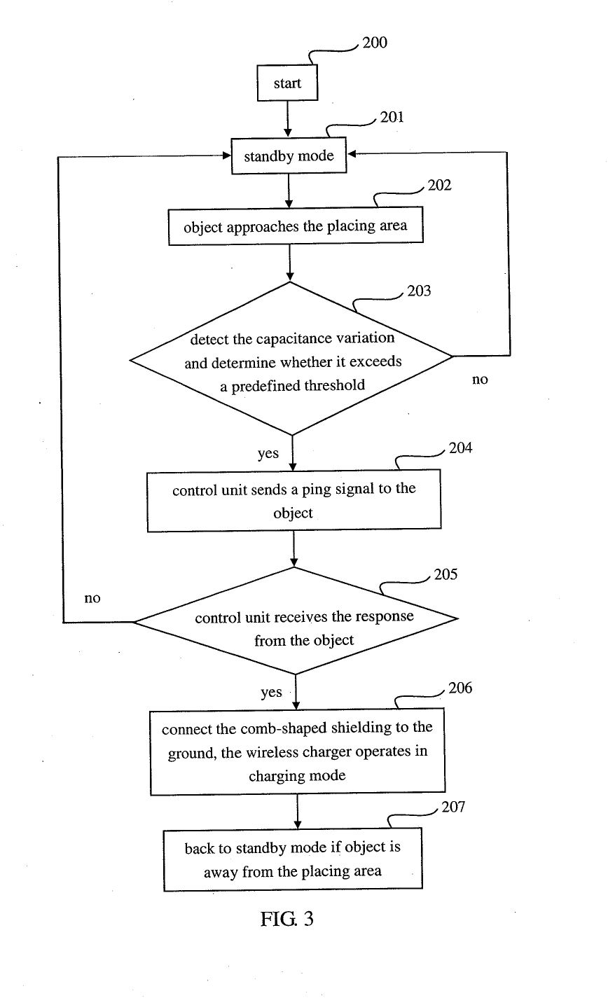

Reffering to FIG. 3, it shows a flow chart illustrating an operation of the embodiment of FIG. 1. As shown in FIG. 3, when the operation starts 200, the wireless charger 100 will be operated in a standby mode, as shown in the function block 201. In the standby mode, the comb-shaped shielding 13 is used as a capacitive sensor electrode for the capacitive sensor 20. By means of the capacitive sensor 20, it detects the changes of the capacitance between the comb-shaped shielding 13 and the environment (such as an object or the electronic device 40). Thus, as shown in function block 202 and 203, if an object approaches the placing area 12 of the wireless charger 100, the capacitance changes, and the control unit 30 determines whether the capacitance variation exceeds a predefined threshold. If yes, the control unit 30 sends a ping signal to the object which is approaching the placing area 12 to identify whether the object is to be charged. Next, as shown in function block 205, if the object is to be charged and is adapted with the wireless charging function, the object will send a response to the control unit 30. As soon as the response is received by the control unit 30, it switches the wireless charger 100 to a charging mode from the standby mode. In function block 206, when the wireless charger 100 is in the charging mode, the control unit 30 motivates the comb-shaped shielding 13 to be connected to the ground 31, and powers on the wireless charger 100 to perform wireless charging. When wireless charging is completed, the object is away from comb-shaped shielding 13, then the capacitance varient is under the predefined threshold. Thus, the control unit 30 switches the wireless charger 100 back to the standby mode, as shown in function block 207.

In such way, the present invention provides a wireless charger 100 having combined electronic radiation shielding and capacitive sensing functions. Thus, when the wireless charger 100 is under standby mode, the controll unit 30 doest not need to continuously send out ping signals to confirm an object is approaching the wireless charger 100. Rather, approaching of an object is detected by the capatitive sensor 20 using the comb-shaped shielding 13 as a capacitive sensor electrode. In addition, when the wireless charger 100 is in the charging mode, the comb-shaped shielding 13 is connected to the ground 31 and serves as a filter. In other words, the comb-shaped shielding 13 enables the first coil 11 to be inductive magnetic coupled to the second coil 41 (the magnetic line (H-fields) can cross the comb-shaped shielding 13 via the spaces 132), however, the accompanied electric radiation (E-fields) is shielded. Thus, the radiation emission of E-fields is reduced.

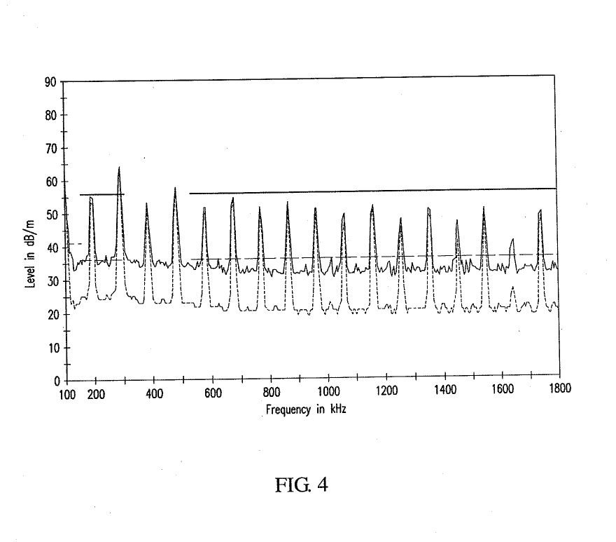

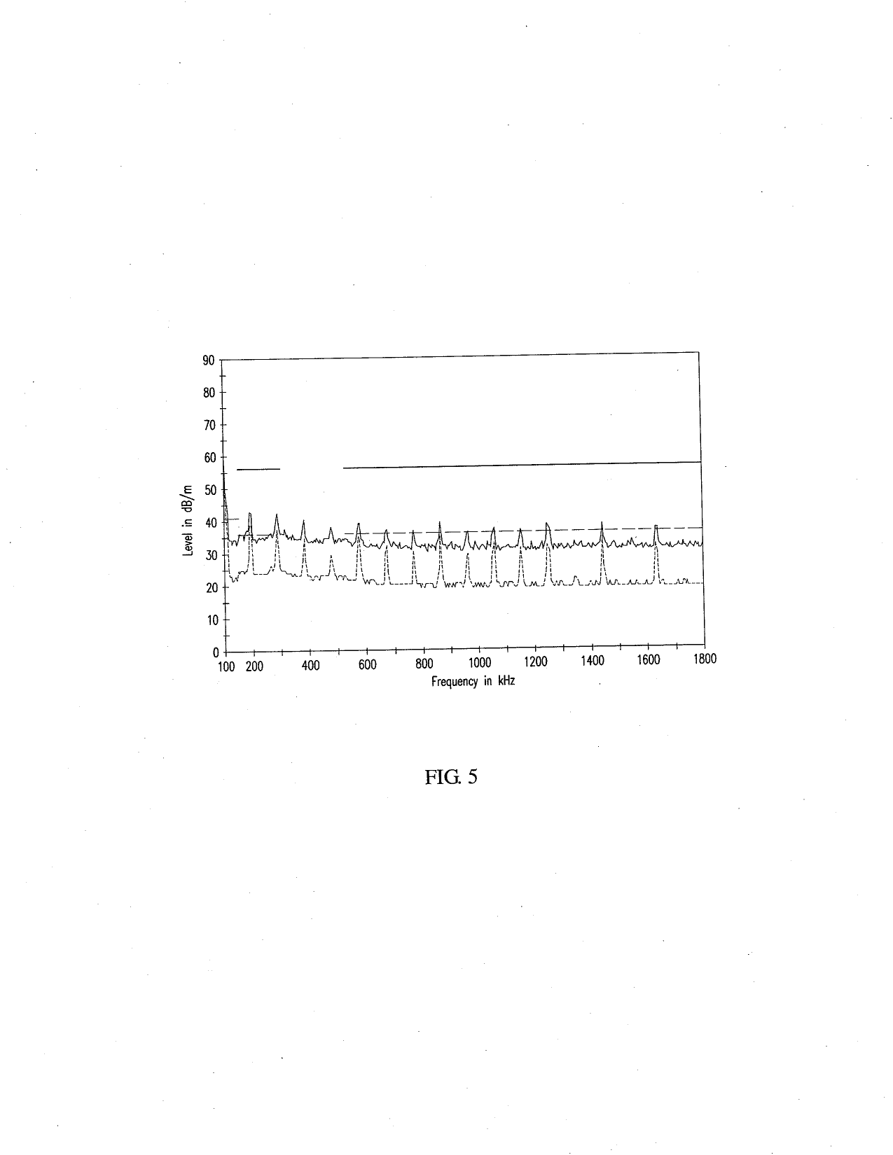

An example was performed to measure the shielding ability of the present invention. FIG. 4 is a chart of the electric radiation emitted from a wireless charger in a charging mode without the comb-shaped shielding. FIG. 5 shows a chart of the electric radiation emitted from a wireless charger in a charging mode with the comb-shaped shielding of the present invention, where the comb-shaped shielding was placed between the charging module and the electronic device. The solid peak lines and the dotted lines in both figures refer to peak detector trace and average detector trace, respectively. The comb-shaped shielding in FIG. 5 is placed transverse to axis of symmetry of the first coil of the charging module. As can be seen from FIG. 4, the electric radiation is significantly above the limited standard of OEM's EMC and EMI specifications in a broad spectrum, whereas there is only a few peaks breaking out the limited standard in FIG. 5. It is proved that the design of the present invention surely can reduce the radiation emission of the E-fields.

The present invention can be used in many different technical fields, such as the the feature of automotive industry, home appliances, consumer electronics, or medical systems.

While the present invention has been described in connection with certain exemplary embodiments, it is to be understood that the invention is not limited to the disclosed embodiments, but, on the contrary, is intended to cover various modificaions and equivalent arrangements included within the spirit and scope of the appended claims, and equivalents thereof.

What is claimed is:

1. A wireless charger for charging an electronic device with a second coil, comprising:
a charging module, comprising a first coil electromagnetically coupled to the second coil, a placing area for the electronic device to be placed on opposite to the first coil, and a comb-shaped shielding located between the placing area and the first coil;
a capacitive sensor, which is connected to the comb-shaped shielding to detect the capacitance varient between the comb-shaped shielding and the environment; and
a control unit, which is connected to the comb-shaped shielding and the capacitive sensor and records the capacitance varient;
wherein, when the capacitance varient exceeds a predefined threshold, the control unit sends a ping signal to the electronic device, and if the electronic device responds, the control unit switches the charging module from a standby mode to a charging mode to wireless charge the electronic device and switches the comb-shaped shielding to be connected to a ground.

2. The wireless charger of claim 1, wherein the control unit further comprises a switch, which is electrically connected between the ground and the comb-shaped shielding.

3. The wireless charger of claim 2, wherein the switch is a transistor.

4. The wireless charger of claim 1, wherein the ping signal is sending from the control unit via the first coil.

5. The wireless charger of claim 1, wherein the comb-shaped shielding comprises a plurality of parallel segments.

6. The wireless charger of claim 1, wherein the comb-shaped shielding is printed as a circuit path on a PCB board.

7. The wireless charger of claim 1, wherein at least two comb-shaped shieldings are used, positioned with different directions against each other and located in different layers of the wireless charger.

8. The wireless charger of claim 1, wherein the comb-shaped shielding is used as a capacitive sensor electrode when the wireless charger is in the stanby mode.

9. A method for combing electric radiation shielding and capacitive sensing functions to a wireless charger, comprising:
(a) detecting a capacitance varient between a comb-shaped shielding of the wireless charger and the environment via a capacitive sensor connected to the comb-shaped shielding in a standby mode;
(b) transmitting a ping signal to confirm an electronic device is to be charged when the capacitance varient exceeds a predefined threshold by a controller;
(c) switching the comb-shaped shielding to be connected to a ground and powering on the wireless charger to perform wireless charging when a response to the ping signal is received in a charging mode; and
(d) switching the wireless charger back to the standby mode when the capacitance varient is under the predefined threshold.

10. The method of claim 9, wherein the wireless charger is connected to a controller to record the capacitance varient and to perform the switch between the standby mode and the charging mode.

11. The method of claim 9, wherein the capacitive sensor is a capacitive sensor integrated circuit.

12. The method of claim 9, wherein the control unit further comprises a switch, which is electrically connected between the ground and the comb-shaped shielding.

13. The method of claim 12, wherein the switch is a transistor.

14. The method of claim 9, wherein the comb-shaped shielding comprises a plurality of parallel segments.

15. The methof of claim 9, wherein the comb-shaped shielding is printed as a circuit path on a PCB board.

16. The method of claim 9, wherein at least two comb-shaped shieldings are used, positioned with different directions against each other and located in different layers of the wireless charger.
